(19) United States
(12) Patent Application Publication
(10) Pub. No.: US 2020/0273331 A1
(43) Pub. Date: Aug. 27, 2020

(54) TRAFFIC LIGHT DEVICE

(71) Applicant: FIGLA, CO., LTD., Toyko (JP)

(72) Inventors: Toshiaki Ito, Honjo-shi (JP); Gaku Okuno, Honjo-shi (JP); Manabu Ogoshi, Honjo-shi (JP); Takakazu Sawada, Honjo-shi (JP); Naoki Horie, Honjo-shi (JP); Hiroyasu Sakawa, Honjo-shi (JP); Yoshikazu Dammura, Tokyo (JP); Norimi Takemura, Tokyo (JP); Akitsugu Wada, Tokyo (JP)

(21) Appl. No.: 16/066,219

(22) PCT Filed: Dec. 28, 2015
(86) PCT No.: PCT/JP2015/086475

§ 371 Date: Jun. 26, 2018

(51) Int. Cl. G08G 1/095; F21V 29/90; F21V 31/00

(52) U.S. Cl. CPC G08G 1/095; F21W 2111/02; F21V 31/005; F21V 29/90

(57) ABSTRACT

A traffic light device for emitting signal light includes: a light emitter unit which includes a light emitter being a light source of the signal light; a body which houses the light emitter unit; and a heater unit provided on a path of the signal light emitted by the light emitter unit inside the body, and including a plate-shaped heating glass, on a surface of which a conductive thin film having transparency is formed, and which generates heat when power is supplied to the conductive thin film via a pair of electrodes.

### TECHNICAL FIELD

The present invention relates to a traffic light device.

### BACKGROUND ART

As for a traffic light device provided at an intersection of a road and the like, there is a problem that a lamp in a region where there is snowfall is difficult to see due to snow accretion on a front surface of a light emitter. Conventionally, in a traffic light device employing an incandescent light bulb as a light emitter, snow accretion on the traffic light device is not a serious problem because most of the snow adhering to the front surface of the light emitter melts due to heat generated from the incandescent light bulb. However, in a traffic light device employing a light-emitting diode (LED), as a light emitter, which has recently become prevalent from the viewpoint of power conservation and maintainability, the amount of heat generated from the LED is much smaller than an incandescent light bulb. For this reason, there arises a problem that insufficient melting of snow by the heat causes snow accretion on the front surface of the light emitter of the traffic light device. From the viewpoint of preventing snow accretion on the traffic light device, as shown in Patent Literature 1, for example, there is proposed a configuration in which a heating element is provided on an inner surface of a transparent cover body that covers the LED light emitter, and this heating element generates heat by receiving an electric current to prevent snow accretion on the surface of the light emitter cover.

### CITATION LIST

### Patent Literature

[PTL 1] Japanese Patent Application Publication No. 2009-145925

### SUMMARY OF INVENTION

### Technical Problem

However, the heating element on the inner side of the cover body described in Patent Literature 1 is a metal strip and therefore may cause a trouble which is a problem in the visibility of the traffic light because the light emitting section with the LED light emitter of the traffic light device is hidden by the strip-shaped heating element when viewed at a distance. In addition, since the heating element generates heat on only a small area of the light emitting section, there is also a problem that the effect of preventing snow accretion is considered insufficient. What is more, there is another problem that the complex shape of the heating element results in a high manufacturing cost and moreover difficulty in attaching the heating element to the cover body.

### Solution to Problem

An aspect of the present invention for solving the problems described above is a traffic light device for emitting signal light, including: a light emitter unit which includes a light emitter being a light source of the signal light; a housing unit for housing the light emitter unit; and a heater unit including a plate-shaped heating glass, which is provided on a path of the signal light emitted by the light emitter unit inside the housing unit, in which a conductive thin film having transparency is formed on a surface thereof, and which generates heat by supplying power to the conductive thin film via a pair of electrodes.

### Advantageous Effects of Invention

The present invention makes it possible to provide a traffic light device including a heater unit, which uniformly heats a large region of a display section of the traffic light, enhancing a snow accretion prevention effect and maintaining visibility during snowfall.

### BRIEF DESCRIPTION OF DRAWINGS

FIG. 1 is a front view of a first example of a traffic light device 1 according to an embodiment of the present invention.

FIG. 2 is a top view of the traffic light device 1 of the first example.

FIG. 3 is a back view of the traffic light device 1 of the first example.

FIG. 4 is a right side view of the traffic light device 1 of the first example.

FIG. 5 is a left side view of the traffic light device 1 of the first example.

FIG. 6 is a front view of a body 10 of the traffic light device 1 of the first example.

FIG. 7 is a right side view of the body 10 of the traffic light device 1 of the first example.

FIG. 8 is a cross-sectional view along A-A of the traffic light device 1 of the first example.

FIG. 9 is a back view of an openable and closable lid section 300 of the traffic light device 1 of the first example.

FIG. 10 is a vertical cross-sectional view of the single openable and closable lid section 300 of the traffic light device 1 of the first example.

FIG. 11 is a cross-sectional view along B-B of the traffic light device 1 of the first example.

FIG. 12 is a partial cross-sectional view of a heater unit 140 of the traffic light device 1 of the first example.

FIG. 13 is a back view of an openable and closable lid section 100 of the traffic light device 1 of the first example.

FIG. 14 is a back view of the openable and closable lid section 100 of the traffic light device 1 of the first example in which a light emitter unit and a spacer are removed.

FIG. 15 is a vertical cross-sectional view of the single openable and closable lid section 100 of the traffic light device 1 of the first example.

FIG. 16 is a back view of the single openable and closable lid section 100 of the traffic light device 1 of the first example.

FIG. 17 is a vertical cross-sectional view of a spacer 150 of the traffic light device 1 of the first example.

FIG. 18 is a front view of the spacer 150 of the traffic light device 1 of the first example.

FIG. 19 is a back view of an openable and closable lid section 200 of the traffic light device 1 of the first example.

FIG. 20 is a back view of the openable and closable lid section 200 of the traffic light device 1 of the first example in which a light emitter unit and a spacer are removed.

FIG. 21 is a back view of the single openable and closable lid section 200 of the traffic light device 1 of the first example.

FIG. 22 is a front view of a spacer 250 of the traffic light device 1 of the first example.

FIG. 23 is a front view of a traffic light device 1A of a second example.

FIG. 24 is a cross-sectional view along D-D of the traffic light device 1A of the second example.

FIG. 25 is a back view of an openable and closable lid section 400 of the traffic light device 1A of the second example.

FIG. 26 is a back view of the openable and closable lid section 400 of the traffic light device 1A of the second example in which light emitter units are removed.

FIG. 26 is a back view of the openable and closable lid section 400 of the traffic light device 1A of a modified example of the second example in which light emitter units are removed.

FIG. 28 is a front view of a body 10A of the traffic light device 1A of the second example.

FIG. 29 is a right side view of the body 10A of the traffic light device 1A of the second example.

FIG. 30 is a front view illustrating an example of a gasket for an openable and closable lid section used in the traffic light device 1 of the first example.

FIG. 31 is a front view illustrating an example of an annular glass gasket on the openable and closable lid side used in the openable and closable lid section 100 of the traffic light device 1 of the first example.

FIG. 32 is a front view illustrating an example of an annular glass gasket on the spacer side used in the openable and closable lid section 100 of the traffic light device 1 of the first example.

FIG. 33 is a front view illustrating an example of a rectangular glass gasket on the openable and closable lid side used in the openable and closable lid section 200 of the traffic light device 1 of the first example.

FIG. 34 is a front view illustrating an example of a rectangular glass gasket on the spacer side used in the openable and closable lid section 200 of the traffic light device 1 of the first example.

FIG. 35 is a partial transverse cross-sectional view illustrating a modified example of the heater unit 140.

FIG. 36 is a partial plan view illustrating the modified example of the heater unit 140.

FIG. 37 is a back view of the openable and closable lid section 200 having the modified example of the heater unit 140 in which a light emitter unit is removed.

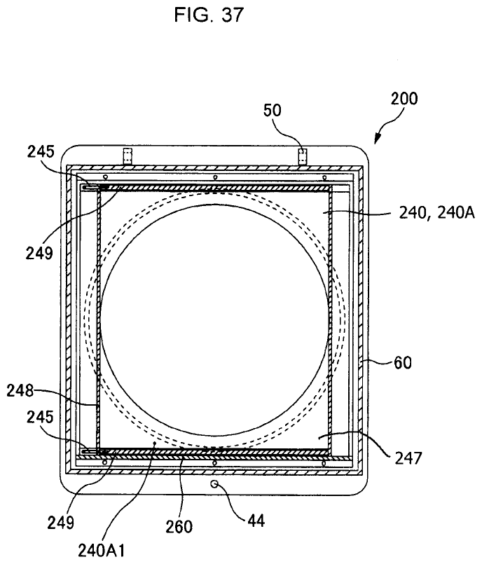

### DESCRIPTION OF EMBODIMENTS

Hereinafter, the present invention is described making reference to the accompanying drawings based on the embodiment and the examples.

### EXAMPLE 1

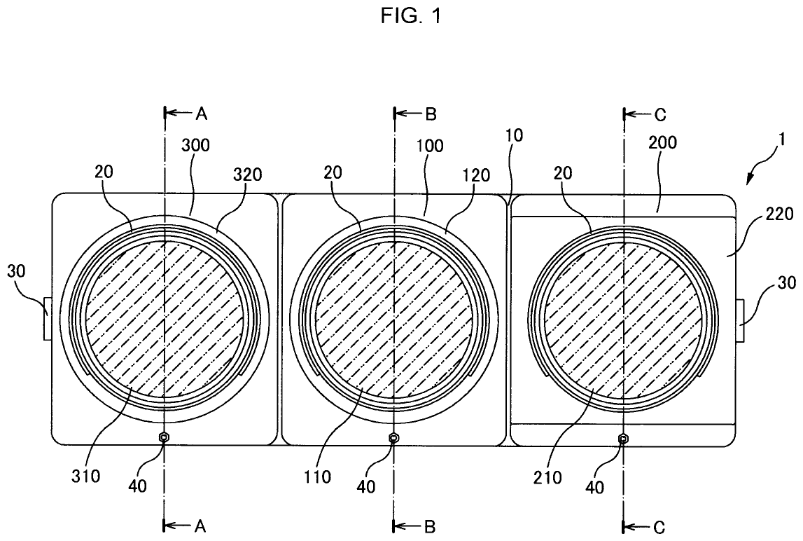

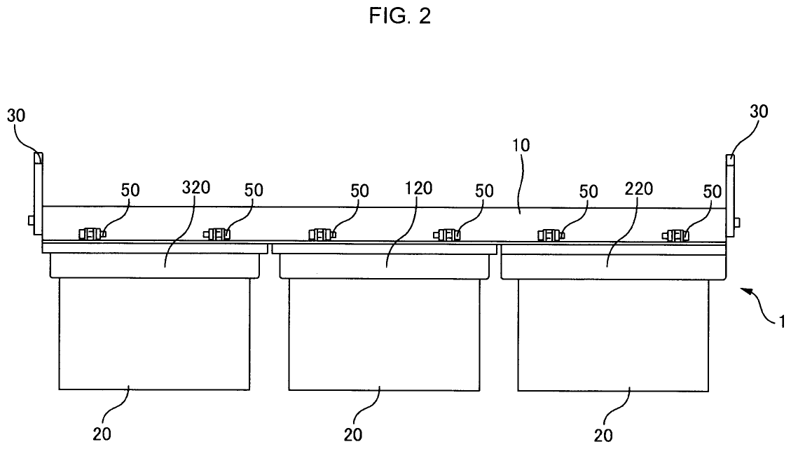

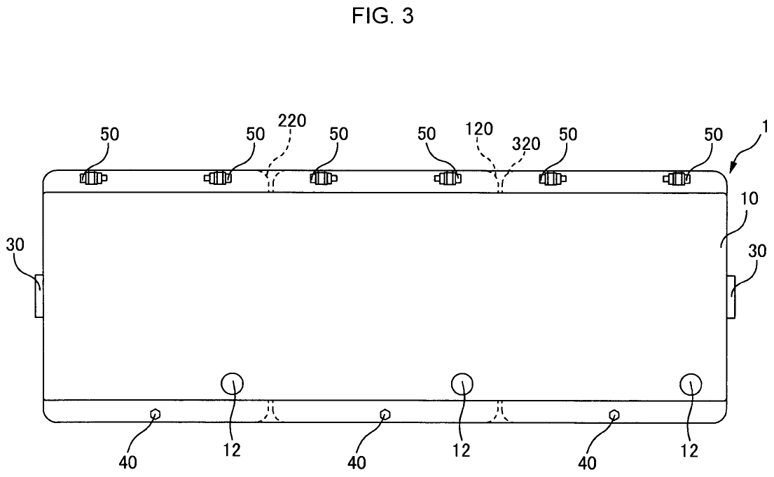

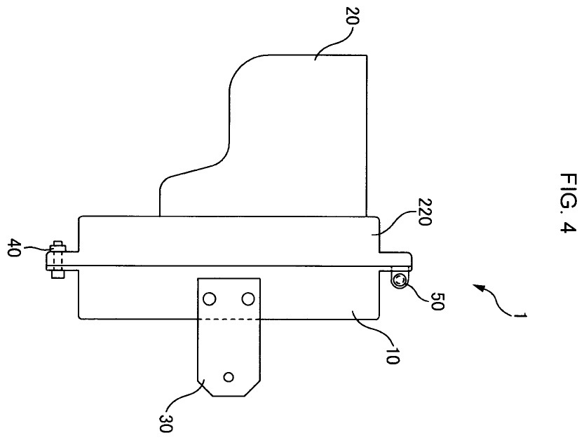

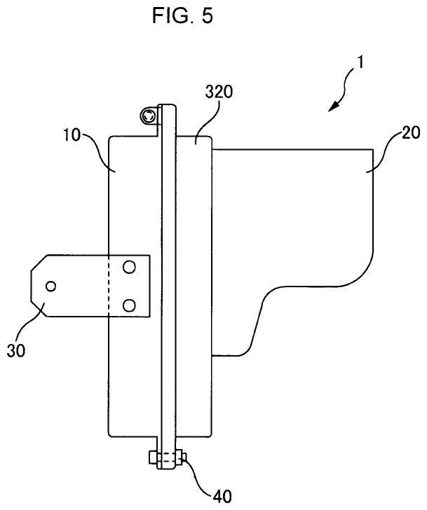

First, as an example of the present invention, a description is provided for a three-lamp traffic light device according to an embodiment of the present invention. FIG. 1 illustrates a front view of a three-lamp traffic light device 1 (hereinafter simply referred to as a “traffic light device 1”) according to the present example, FIG. 2 illustrates a top view of the traffic light device 1, FIG. 3 illustrates a back view of the traffic light device 1, FIG. 4 illustrates a right side view of the traffic light device 1, and FIG. 5 illustrates a left side view of the traffic light device 1. Note that the number of lamps may be one or more except three.

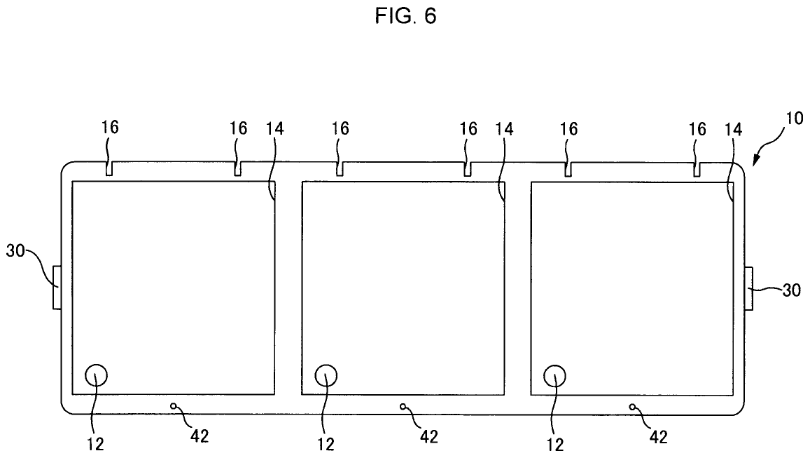

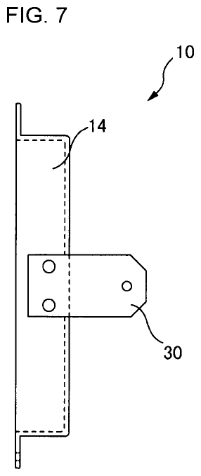

As illustrated in FIG. 1, the traffic light device 1 of the present example is a general horizontal traffic light device which is configured to turn on the lamps in three colors, i.e. red, yellow, and green. The traffic light device 1 is provided with three light emitting units 110, 210, and 310 each of which is about 30 cm in diameter. The light emitting unit 110 emits yellow light, the light emitting unit 210 emits red light, and the light emitting unit 310 emits green light. The light emitting units 110 to 310 are respectively housed in independent openable and closable lid sections 100 to 300 (housing units) having substantially rectangular shape, and are attached to a body 10 which has three rectangular plane-shaped recessed portions 14 for housing light sources and the like provided in the openable and closable lid sections 100 to 300. FIG. 6 illustrates a front view of the body 10 and FIG. 7 illustrates a right side view of the body 10. Specific shapes, dimensions, materials, and the like of the openable and closable lid sections 100 to 300 and the body 10 making up the traffic light device 1 can be determined by the related laws and regulations and the like.

The light emitting units 110 to 310 of the traffic light device 1 are provided inside box sections 120 to 320 protruding from the front surfaces of the openable and closable lid sections 100 to 300, respectively. In the example of FIG. 1, the box sections 120 and 320 have cylindrical transverse cross-sections, and the box section 220 has a square transverse cross-section. The shapes of the transverse cross-sections of the box sections 120 to 320 correspond to the shapes in a plan view of the heating elements (to be described later) used in the light emitting units 110 to 310. A substantially arc-shaped hood 20 is attached around each of the light emitting units 110 to 310, preventing reduction of visibility by shutting direct sunlight to the lamps and suppressing snow accretion on the light emitting units 110 to 310 during snowfall. Each of the openable and closable lid sections 100 to 300 is detachably attached to the body 10 with hinge components 50 such that it is openable and closable relative to groove portions 16 of the body 10. Each of the openable and closable lid sections 100 to 300 is configured such that when closed, it is fixed to a hole portion 42 provided in a lower side portion of the body 10 with a fixing screw 40.

At both end portions in a longitudinal direction of the body 10 of the traffic light device 1, brackets 30 for fixing the body 10 to an attachment pillar and the like of the traffic light device 1 are provided. On the back surface of the body 10, as illustrated in FIG. 6, opening portions 12 for letting out cables from the light emitting units 110 to 310 to the outside of the traffic light device 1 are provided. It is possible to provide each of the opening portions 12 with an appropriate bush, seal, and the like in order to prevent rainwater, foreign matter, and the like from entering the body 10.

Next, a description is provided fora configuration example of the light emitting units 110 to 310 provided in the traffic light device 1 of the present example and the openable and closable lid sections 100 to 300 housing these. For convenience of explanation of the present invention, the three-lamp traffic light device 1 illustrated in FIG. 1 and the like is assumed to be provided with light emitting units 110 to 310 having configurations different among one another. To be more specific, the openable and closable lid section 300 provided with the light emitting unit 310 has a conventional general configuration without any heating element for suppressing snow accretion on the light emitting unit 310. As opposed to this, the openable and closable lid section 100 provided with the light emitting unit 110 is provided with a heating element having a circular shape in a plan view, and the openable and closable lid section 200 provided with the light emitting unit 210 is provided with a heating element having a substantially square shape in a plan view. To sum up, in the case of the three-lamp traffic light device 1 according to the present invention, the configuration is usually that of the openable and closable lid section 100 or 200 in practice.

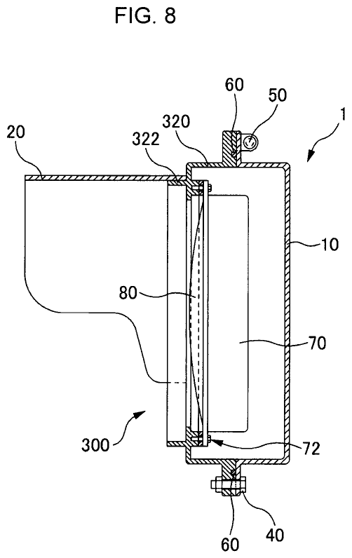

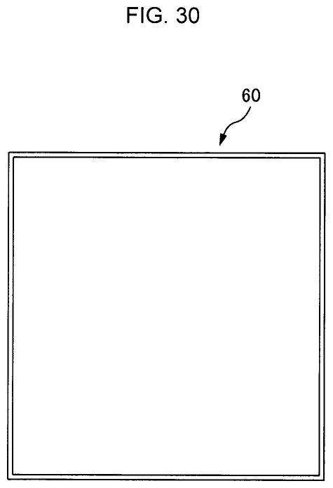

To clarify the structure of the general traffic light device 1, a description is provided for the configuration of the portions of the openable and closable lid section 300. FIG. 8 illustrates a transverse cross-sectional view of the openable and closable lid section 300 portion of the traffic light device 1. This corresponds to the cross-section along A-A of FIG. 1. As already described, the openable and closable lid section 300 is attached to the body 10 with the hinge components 50 such that it is openable and closable. On the surface of the openable and closable lid section 300 to closely contact with the body 10, a gasket 60 is provided surrounding an outer periphery of the recessed portion 14 of the opposing body 10, and the openable and closable lid section 300 is configured to closely contact with the body 10 in a sealed state. The gasket 60 is formed of a synthesized resin material or the like having an appropriate mechanical property. FIG. 30 illustrates a front view of the gasket 60.

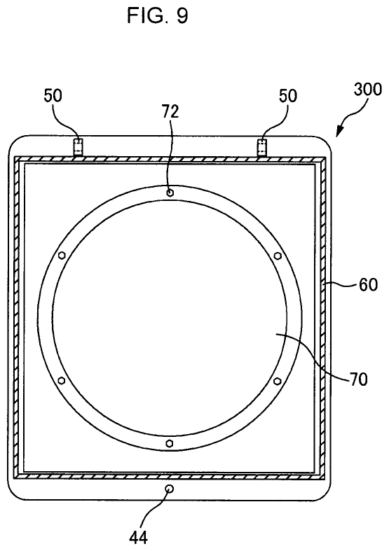

As illustrated in FIG. 8, a light emitter unit 70 is attached to the back surface of the openable and closable lid section 300 with attachment bolts 72. In the present example, the light emitter unit 70 houses a circuit board to which an LED as a light source is attached, and the front surface thereof is provided with a convex surface cover 80 which is a member having transparency for collecting light. The openable and closable lid section 300 is provided with a cylindrically protruding box section 320, and the front surface thereof is further provided with an annular protruding portion 322. The hood 20 is secured to the outer periphery of the annular protruding portion 322 using appropriate fixing means. FIG. 9 is a back view of the openable and closable lid section 300, in which the back surface of the light emitter unit 70 is visible. The outer peripheral portion to contact with the body 10 is provided with groove portions 62 for receiving the gasket 60, and the gasket 60 is fitted thereinto. The hole portion 44 is provided in order to insert the fixing screw 40 for fixing the openable and closable lid section 300 to the body 10 therethrough.

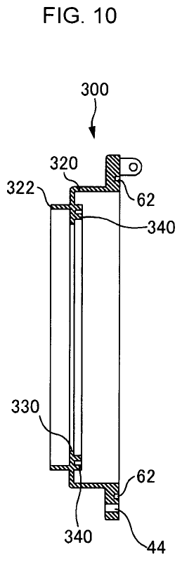

FIG. 10 is a cross-sectional view illustrating the openable and closable lid section 300 depicted in FIG. 8 and FIG. 9 as a single component, in which all attachment components are removed. Since the configuration of the openable and closable lid section 300 has already been described, overlapping explanation will be omitted. An opening portion 330 is provided in the box section 320 of the openable and closable lid section 300. Light emitted from the light emitter unit 70 comes out through the convex surface cover 80 from the opening portion 330.

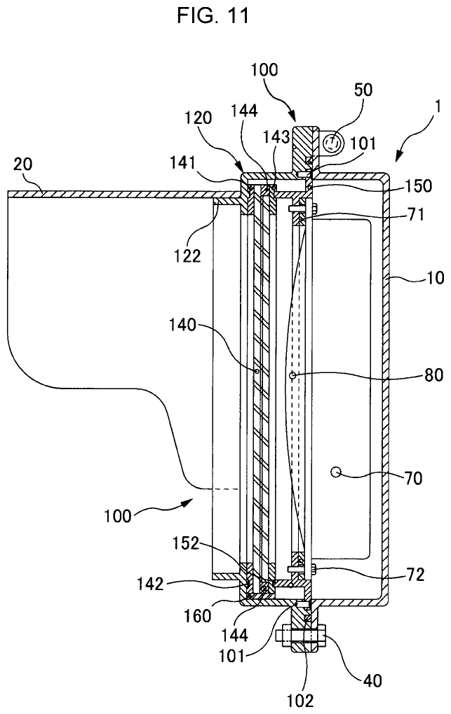

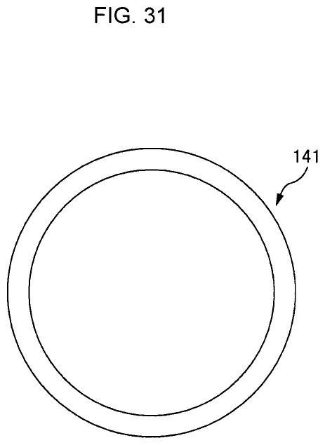

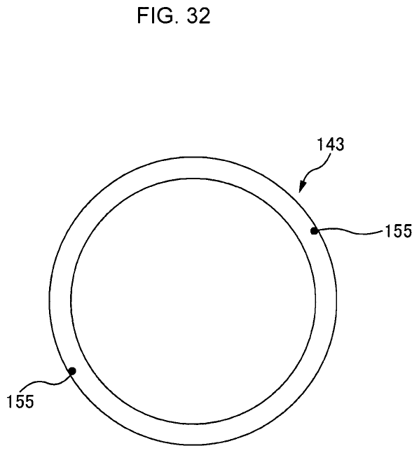

Next, a description is provided for the configuration of the openable and closable lid section 100 in which the heating element is provided. FIG. 11 illustrates a transverse cross-sectional view of the openable and closable lid section 100 portion of the traffic light device 1. This corresponds to the cross-section along B-B of FIG. 1. Hereinafter, a description is mainly provided for the configurations different from those of the openable and closable lid section 300. In the openable and closable lid section 100, the heater unit 140 as a heating element is provided in front of the light emitter unit 70 and the convex surface cover 80. The heater unit 140 has a circular shape in a plan view, and a pair of annular glass gaskets 141 and 143 (to be described later) sandwiches both sides thereof. Each of the annular glass gaskets 141 and 143 is formed of a synthesized resin material or the like having an appropriate mechanical property. FIG. 31 illustrates a front view of the annular glass gasket 141 provided between the heater unit 140 and the openable and closable lid section 100. In addition, FIG. 32illustrates a front view of the annular glass gasket 143 provided between the heater unit 140 and the spacer 150. The annular glass gasket 143 is provided with a lead outlet hole 143A for letting out a lead 145 (to be described later) of the heater unit 140.

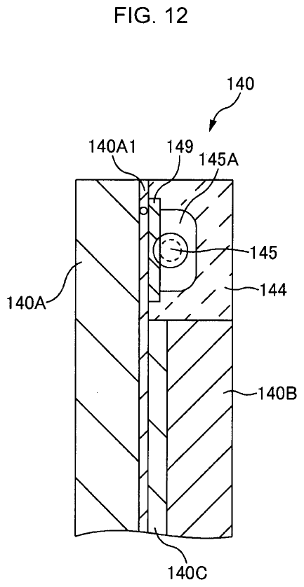

FIG. 12 illustrates an example of a partial cross-sectional view of the heater unit 140. The heater unit 140 is made by bonding together heating glass 140A formed by a light-transmitting conductive thin film 140A1 on the surface of the transparent glass plate and float glass 140B being a transparent glass plate such that the conductive thin film 140A1 is located on the inner side while sandwiching an intermediate film 140C formed of polyvinyl butyral (PVB), ethylene vinyl acetate (EVA) resin, or the like. The conductive thin film 140A1 is provided with an electrode 149 formed of a conductive tape, silver paste, or the like, and the lead 145 is mechanically and electrically coupled thereto using solder 145A. The electrode 149, the lead 145, and the solder 145A are sealed using silicone sealant 144 so as to fill the step portion of the glass. The lead 145 is coupled to an illustration-omitted commercial alternating power supply using an appropriate switch, contactor, and the like. The lead 145 generates heat by supplying an alternating current through the conductive thin film 140A1 of the heater unit 140 as necessary. Heat generated from the heater unit 140 makes it possible to effectively prevent snow accretion on the outer surface side of the traffic light device 1 of the heater unit 140.

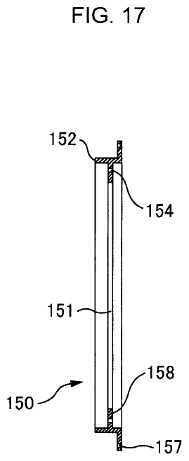

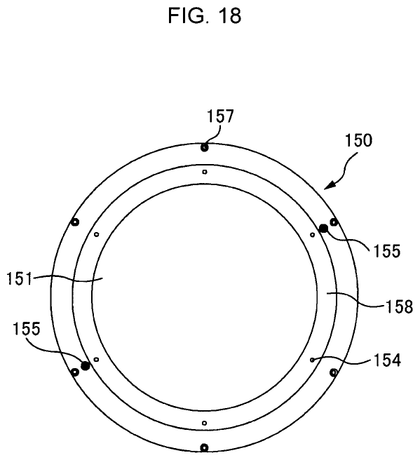

As illustrated in FIG. 11, the heater unit 140 is provided between the inner end surface of the box section 120 of the openable and closable lid section 100 and the spacer 150 (fixing member) with the annular glass gaskets 141 and 143 interposed therebetween. In other words, the heater unit 140 is provided on the path of the light emitted from the light emitter unit 70. FIG. 17 and FIG. 18 illustrate a configuration example of the spacer 150. FIG. 17 is a cross-sectional view across the center of the spacer 150, and FIG. 18 is a front view of the spacer 150. The spacer 150 is a substantially annular member having a circular hole portion 151, and is provided with an annular erected portion 152 along the periphery of the circular hole portion 151. A ring portion 158 being an annular plate material projecting along the inner periphery of the annular erected portion 152 is formed. The spacer 150 can be obtained by forming processing of an appropriate resin material or a metal material such as die-cast. Reference to FIG. 11 shows that the spacer 150 is provided flush with the surface of the base portion being a portion of the openable and closable lid section 100 to contact with the body 10, and that the spacer 150 is fixed relative to the base portion by screwing bolts 101 into bolt holes 157. In addition, the light emitter unit 70 is fixed to the ring portion 158 of the spacer 150 using a gasket 71 by screwing bolts 72 into screw holes 154.

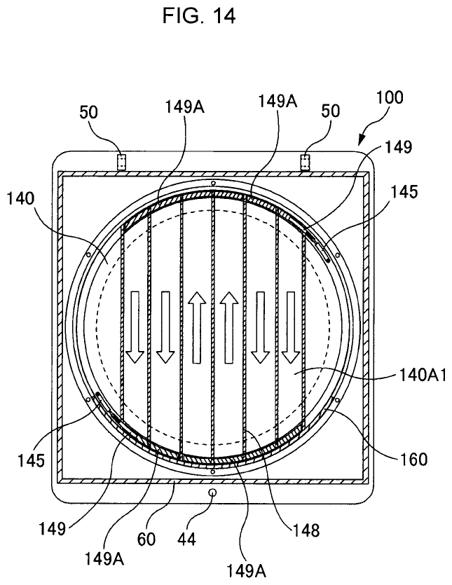

On the other hand, as described above, the heater unit 140 is fixed inside the box section 120 of the openable and closable lid section 100 by the spacer 150 when a gasket-pressing rib 142 annularly provided in the inner end surface of the box section 120 of the openable and closable lid section 100 in a protruding manner contacts with the annular glass gasket 141 and in addition when the end portion of the annular erected portion 152 of the spacer 150 contacts with the annular glass gasket 143. The height dimension of the annular erected portion 152 of the spacer 150 may be determined such that the heater unit 140 and the glass gaskets 141 and 143 are fixed between the gasket-pressing rib 142 and the annular erected portion 152 by the elastic force of the glass gaskets 141 and 143. The lower end portion of the heater unit 140 is supported by an arc-shaped support block 160 having elasticity so as to prevent breakage due to contact with the inner side surface of the box section 120 of the openable and closable lid section 100 (for example, see FIG. 14).

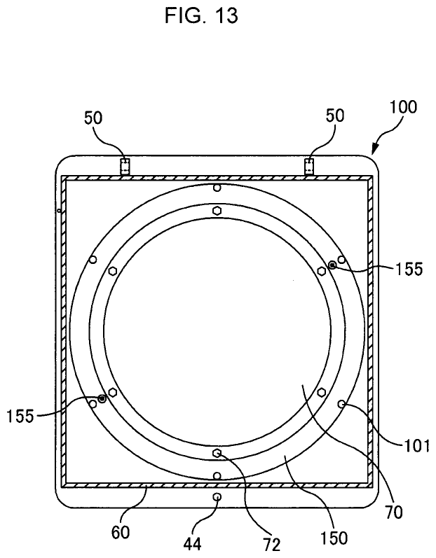

FIG. 13 illustrates a back view of the openable and closable lid section 100. As described using the cross-sectional view of the openable and closable lid section 100 of FIG. 11, the light emitter unit 70 is fixed to the spacer 150 with the bolts 72, and the spacer 150 is fixed to the base portion of the openable and closable lid section 100 with the bolts 101. As in the case of the openable and closable lid section 300, the base portion of the openable and closable lid section 100 is provided with the gasket 60 along the outer peripheral edge thereof. In addition, the rectangular substrate of the spacer 150 is provided with hole portions 155 at two locations for letting out the lead 145 from the heater unit 140.

FIG. 14 illustrates the back surface of the openable and closable lid section 100 in which the light emitter unit 70 and the spacer 150 are removed. Since the spacer 150 is removed in FIG. 14, the surface of the heater unit 140 is visible. The conductive thin film 140A1 provided on the heating glass 140A of the heater unit 140 is divided into eight regions by seven strip-shaped film-removed portions 148. Each of the film-removed portions 148 is a region from which the conductive thin film 140A1 is removed by sandblasting in the shape of a strip, and the width thereof can be determined appropriately depending on the area of the conductive thin film. In the illustrated example, the upper edges of the second and the third of the eight divided regions from the right end are electrically coupled using a conductive tape 149A, and the electrode 149 and the lead 145 are attached to the conductive tape 149A. The lower end portions of the first to the fourth regions from the right end of the conductive thin film 140A1 are electrically coupled by the conductive tape 149A. In addition, the upper end portions of the third to the sixth regions from the right end of the conductive thin film 140A1 are electrically coupled by the conductive tape 149A. Moreover, the lower end portions of the fifth and the sixth regions from the right end of the conductive thin film 140A1 are electrically coupled by the conductive tape 149A, and the electrode 149 and the lead 145 are attached to the conductive tape 149A. The pair of leads 145 is coupled to the not-illustrated commercial alternating power supply using an appropriate switch, contactor, and the like. FIG. 14 schematically illustrates with wide arrows the paths of electric currents flowing through the conductive thin film 140A1 having the configuration described above. As described later, in the present example, the illustrated wide arrows indicate directions of current in a cross-section viewed at a certain time because an alternating voltage is applied between the electrodes 149. The illustrated configuration of the present example is designed such that when AC voltage 100 V is applied between the pair of electrodes 149, for example, heat of about 35 W is obtained and the temperature rise on the surface of the heating glass 140A is about 40° C. The electrical resistance value between the electrodes 149 in this case is about 280Ω. This makes it possible to obtain an effect of preventing snow accretion on the light emitting unit 110 of the traffic light device 1.

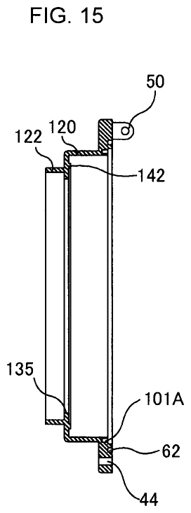

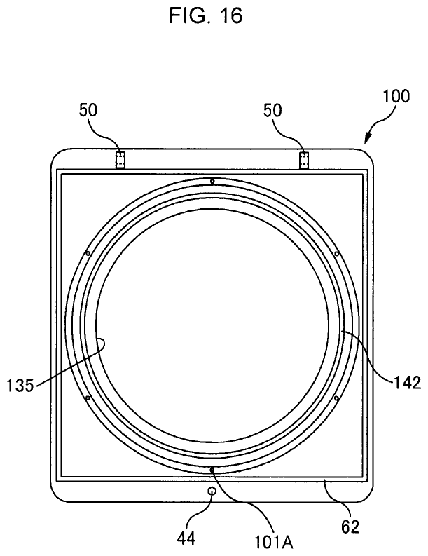

FIG. 15 and FIG. 16 illustrate a cross-sectional view and a back view of the single openable and closable lid section 100, respectively. The configuration of the openable and closable lid section 100 has already been described making reference to FIG. 11 and the like. Additionally, the annular gasket-pressing rib 142 is provided on the inner end surface of the box section 120 in a protruding manner to surround the opening portion 135, and is configured to closely contact with the annular glass gasket 141 attached to the heating glass 140A of the heater unit 140.

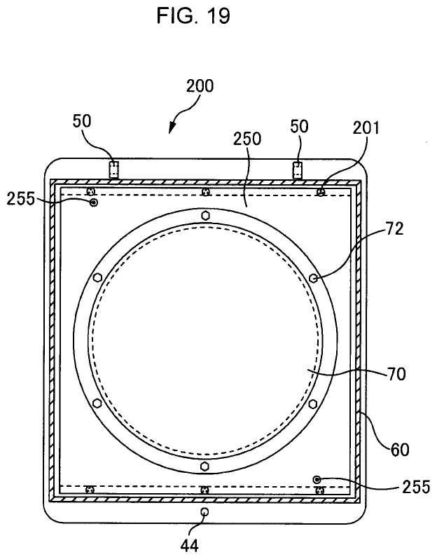

Next, a description is provided for the configuration of the openable and closable lid section 200 provided with a heating element as in the case of the openable and closable lid section 100. The openable and closable lid section 200 is different from the openable and closable lid section 100 in that it is provided with a rectangular plane-shaped heater unit 240 as a heating element. Since the cross-sectional view across the cross-section along C-C of the openable and closable lid section 200 in FIG. 1 appears in the same manner as FIG. 11 concerning the openable and closable lid section 100, illustration and description thereof are omitted. The heater unit 240 has a configuration similar to that of the heater unit 140 except that it has a rectangular shape in a plan view and the conductive thin film 240A1 is removed in a different manner as described later. Thus, overlapping explanation will be omitted. Note that FIG. 19 to FIG. 22 illustrate the elements corresponding to those of the openable and closable lid section 100 such that the reference sign of the corresponding element has two at the hundreds place, as seen in the relationship between openable and closable lid sections 100 and 200.

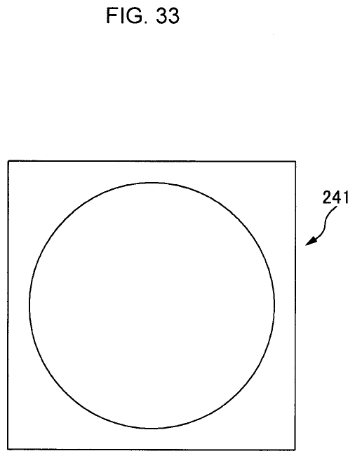

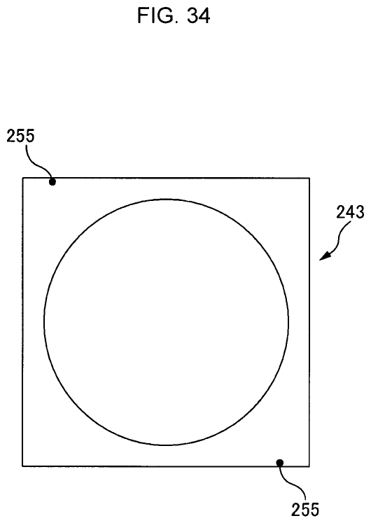

As described above, the heater unit 240 of the openable and closable lid section 200 has a rectangular shape in a plan view, and a pair of rectangular glass gaskets 241 and 243 sandwiches both sides thereof. FIG. 33 and FIG. 34 illustrate the rectangular glass gaskets 241 and 243. The rectangular glass gasket 241 provided between the heater unit 240 and the openable and closable lid section 200 has a rectangular plane with shape and dimensions similar to those of the heating glass 140A of the heater unit 140, and is provided with a circular opening portion corresponding to an opening portion 235 of the openable and closable lid section 200. On the other hand, as illustrated in FIG. 34, the rectangular glass gasket 243 provided on the spacer 250 side to be described later has almost the same configuration as the rectangular glass gasket 241 provided on the openable and closable lid section 200 side, but is different in that it is provided with outlet holes 255 for the leads from the heater unit 240.

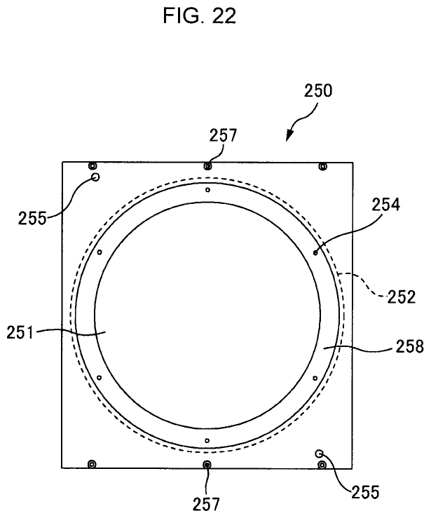

As in the case of the openable and closable lid section 100, also in the openable and closable lid section 200, the heater unit 240 is provided between the inner end surface of the box section 220 of the openable and closable lid section 200 and the spacer 250 with the rectangular glass gaskets 241 and 243 interposed therebetween. FIG. 22 illustrates a front view of the spacer 250. The cross-sectional view across the center of the spacer 250 appears in the same manner as FIG. 17 concerning the openable and closable lid section 100. The spacer 250 is a member in which the rectangular substrate having the circular hole portion 251 is provided with an annular erected portion 252 along the periphery of the circular hole portion 251 and in which a ring portion 258 being an annular plate material projecting along the inner periphery of the annular erected portion 252 is formed. The spacer 250 of FIG. 22 has predetermined positions of bolt holes 257 for attachment into the box section 220 of the openable and closable lid section 200 having a rectangular transverse cross-section and predetermined positions of outlet holes 255 for the leads from the heater unit 240, in consideration of the fact that the shape of the corresponding heater unit 240 in a plan view is rectangular.

As in the case of the openable and closable lid section 100, the heater unit 240 is fixed inside the box section 220 of the openable and closable lid section 200 by the spacer 250 when a gasket-pressing rib 252 annularly provided in the inner end surface of the box section 220 of the openable and closable lid section 200 in a protruding manner contacts with the glass gasket 241 and in addition when the end portion of the annular erected portion 252 of the spacer 250 contacts with the glass gasket 243. As in the case of the openable and closable lid section 100, the height dimension of the annular erected portion 252 of the spacer 250 may be determined such that he heater unit 240 and the glass gaskets 241 and 243 are fixed between the gasket-pressing rib 242 and the annular erected portion 252 by the elastic force of the glass gaskets 241 and 243. The lower end portion of the heater unit 240 is supported by a support block 260 (see FIG. 19, same as the support block 160) having elasticity so as to prevent breakage due to contact with the inner side surface of the box section 220 of the openable and closable lid section 200.

FIG. 19 illustrates a back view of the openable and closable lid section 200. As in the case of the openable and closable lid section 100, reference to FIG. 19 shows that the light emitter unit 70 is fixed to the spacer 250 with the bolts 72, and the spacer 250 is fixed to the base portion of the openable and closable lid section 200 with the bolts 201. The base portion of the openable and closable lid section 200 is provided with a gasket 202 along the outer peripheral edge thereof. In addition, the rectangular substrate of the spacer 250 is provided with hole portions 255 at two locations for letting out the lead 245 from the heater unit 240.

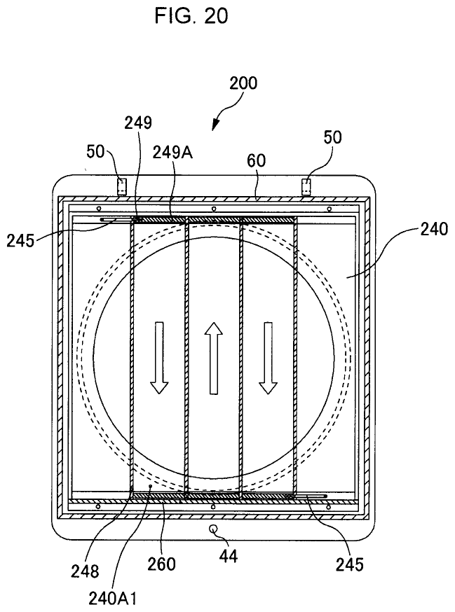

FIG. 20 illustrates the back surface of the openable and closable lid section 200 in which the light emitter unit 70 and the spacer 250 are removed. Since the spacer 250 is removed in FIG. 20, the surface of the heater unit 240 is visible. The conductive thin film 240A1 provided on the heating glass 240A of the heater unit 240 is divided into five regions by four film-removed portions 248. In the illustrated example, a lower edge of the second region from the right end is electrically coupled using a conductive tape 249A, and the electrode 249 and the lead 245 are attached to the conductive tape 249A. The upper end portions of the first and the second regions from the right end of the conductive thin film 240A1 are electrically coupled by the conductive tape 249A. In addition, the lower end portions of the third and the fourth regions of from the right end of the conductive thin film 240A1 are electrically coupled by the conductive tape 249A. Moreover, the upper end portion of the fourth region from the right end of the conductive thin film 240A1 is provided with the conductive tape 249A, and the electrode 249 and the lead 245 are attached to the conductive tape 249A. The pair of leads 245 is coupled to the not-illustrated commercial alternating power supply using an appropriate switch, contactor, and the like. As in the case of FIG. 14, FIG. 20 schematically illustrates with wide arrows the paths of electric currents flowing through the conductive thin film 240A1 having the configuration described above. As in the case of the heater unit 140 of the openable and closable lid section 100, the illustrated configuration of the present example is designed such that when AC voltage of 100 V is applied between the pair of electrodes 249, for example, heat of about 48 W is obtained and the temperature rise on the surface of the heating glass 240A is about 40° C. The electrical resistance value between the electrodes 249 in this case is about 210Ω. This makes it possible to obtain an effect of preventing snow accretion on the light emitting unit 210 of the traffic light device 1.

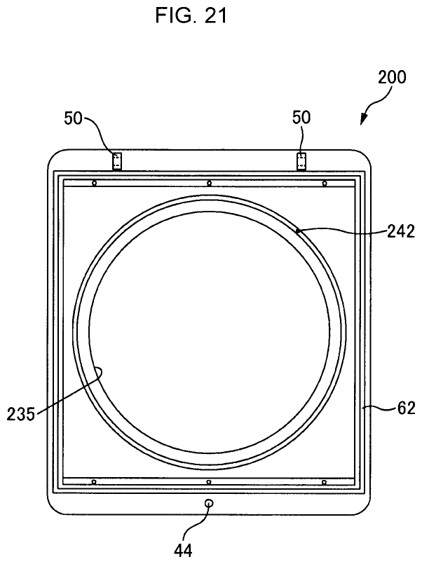

FIG. 21 illustrates a back view of the single openable and closable lid section 200. Since the cross-sectional view corresponding to FIG. 21 appears in the same manner as FIG. 15 in the openable and closable lid section 100, illustration and explanation are omitted. The configuration of the openable and closable lid section 200 has already been described with reference to FIG. 11, FIG. 19, and the like. The annular gasket-pressing rib 242 is provided on the inner end surface of the box section 220 in a protruding manner to surround the opening portion 235, and is configured to closely contact with the rectangular glass gasket 241 provided between the gasket-pressing rib 242 and the heating glass 240A of the heater unit 240.

The traffic light device 1 according to the example described above makes it possible to provide a heater unit in front of a light emitter unit for turning on a traffic light and to heat this heater unit as necessary by allowing an electric current to pass therethrough. Thus, it is possible to effectively prevent snow accretion which leads to the reduction in visibility of the traffic light. In addition, the heater unit is brought into close contact with an openable and closable lid section and a spacer secured thereto using a gasket between the openable and closable lid section and the spacer. Thus, the sealing property inside the traffic light device 1 is maintained, which effectively prevents external rainwater and the like from entering the inside.

### SECOND EXAMPLE

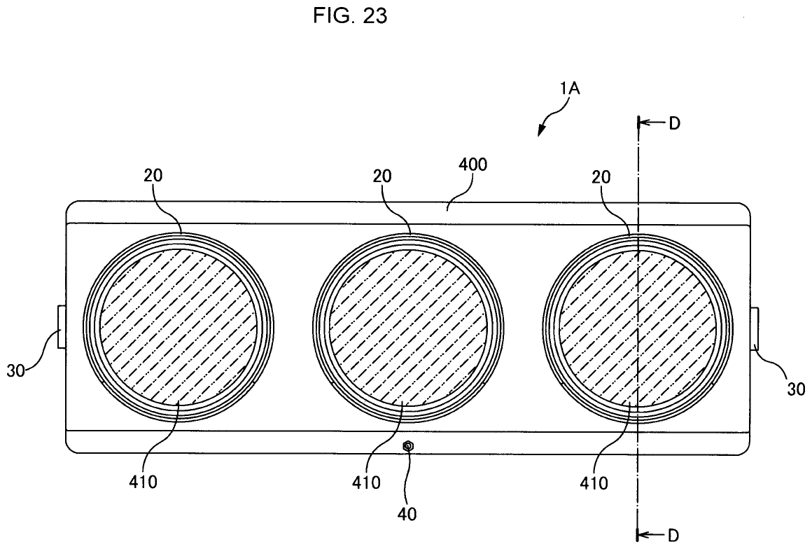

Next, a description is provided for a second example according to an embodiment of the present invention. FIG. 23 illustrates a front view of a traffic light device 1A according to the second example. The traffic light device 1A is a three-lamp traffic light device as in the case of the first example, but is different in that three light emitting units 410 are provided to the openable and closable lid section 400. The openable and closable lid section 400 is fixed in the closed state to the body 10A with a fixing bolt 40. Brackets 30 for fixing are provided at both end portions of the body 10A as in the case of the first example.

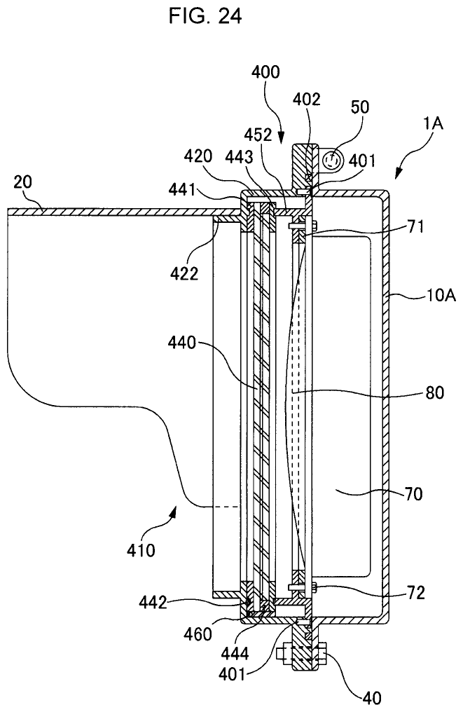

FIG. 24 illustrates a cross-sectional view of the traffic light device 1A viewed in a cross-section along D-D of FIG. 23. The heater unit 440 is held while being sandwiched between a gasket-pressing rib 442 formed on the inner end surface of the box section 420 of the openable and closable lid section 400 and an end portion of an annular erected portion 452 of a spacer 450 using glass gaskets 441 and 443. Here, the configuration is such that the gasket-pressing rib 442 is pressed to the glass gasket 441 and the spacer 450 is pressed to the glass gasket 443, tightly sealing the inside of the traffic light device 1A. Similarly, a gasket 402 is provided between the openable and closable lid section 400 and the body 10 in order to maintain the sealing property of the traffic light device 1A. The openable and closable lid section 400 is fixed to the body 10 with the fixing bolt 40 in the closed state. Annular protruding portions 422 corresponding to the three light emitting units 410 are provided on the box section 420 having a rectangular shape in a plan view along the entire length of the traffic light device 1A in the longitudinal direction. A hood 20 is attached to each of the annular protruding portions 422. The lower end portion of the heater unit 440 is supported by a support block 460 provided on the bottom surface of the box section 420 so as to prevent breakage due to vibration or the like.

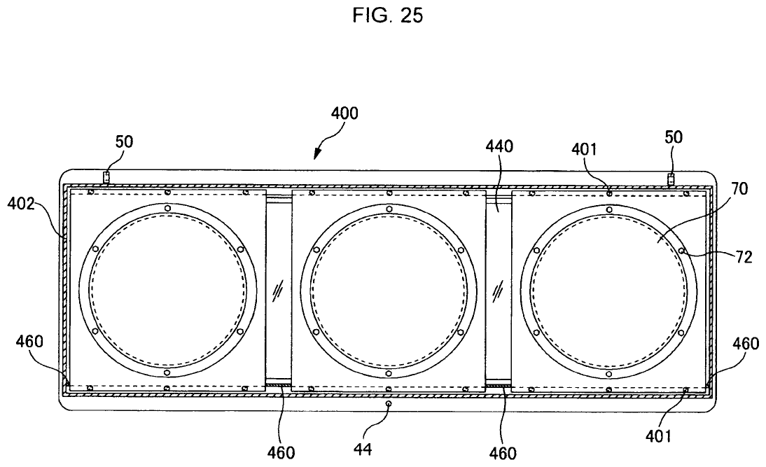

FIG. 25 is a back view of the openable and closable lid section 400. In the openable and closable lid section 400, the light emitter units 70 are provided at positions corresponding to the light emitting units 410, and each of the light emitter units 70 is fixed to the spacer 450 with the bolts 72. In the openable and closable lid section 400, the heater unit 440 is formed in the shape of a horizontally long rectangle so as to be provided across the three light emitting units 410. The gasket 402 for sealing the space in the body 10 is provided to surround the three light emitting units 410.

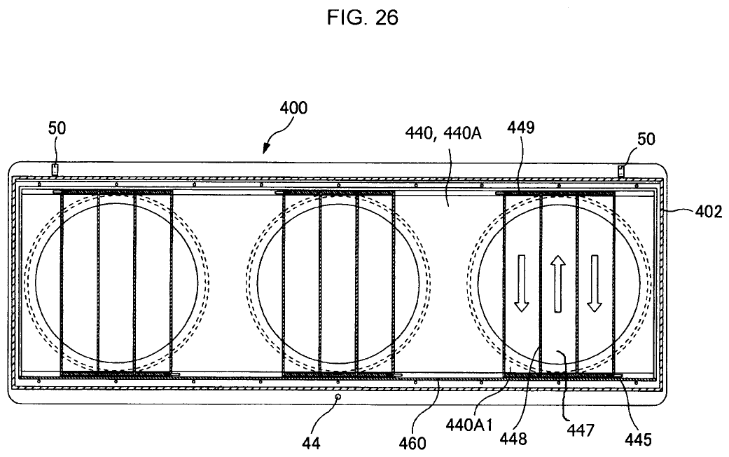

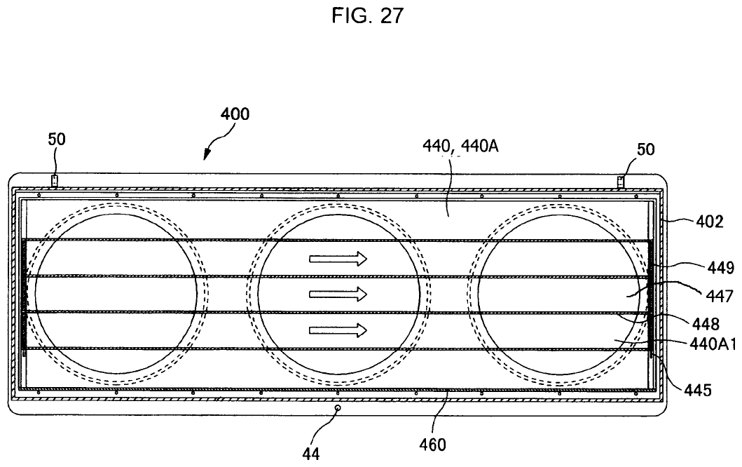

FIG. 26 illustrates a back view in which the light emitter units 70 and the spacers 450 are removed from the openable and closable lid section 400 of the traffic light device 1A. In FIG. 26, the entire heater unit 440 having the shape of a horizontally long rectangle in a plan view is visible. In the heater unit 440, four film-removed portions 448 are provided in a region corresponding to each of the three light emitting units 410. Thus, three conductive regions 447 corresponding to the openable and closable lid section 200 of the first example illustrated in FIG. 20 are formed between a pair of electrodes 449. The cross-sectional structure of the heater unit 440 is the same as that of FIG. 12 in the first example (the elements corresponding to the elements of FIG. 12 have four at the hundreds place instead of one in the reference signs of FIG. 12). As in the case of FIG. 14, FIG. 26 schematically illustrates with wide arrows the paths of electric currents flowing through the conductive thin film 440A1 having the configuration described above. The present example is designed such that when AC voltage of 100 V is applied between each of the pairs of electrodes 445, heat of about 48 W is obtained because the configuration of conductive film is the same as the heater unit 240, and the temperature rise on the surface of the heating glass 140A is about 40° C. In this case, the electrical resistance value between the electrodes 449 is about 210Ω.

FIG. 27 illustrates a modified example of the heater unit 440 in the present example. In the example of FIG. 27, a pair of electrodes 449 is provided at both end portions in the longitudinal direction of the horizontally long rectangular heater unit 440, and three conductive regions 447 formed by four film-removed portions 448 are provided between the electrodes. As in the case of FIG. 14, FIG. 27 schematically illustrates with wide arrows the paths of electric currents flowing through the conductive thin film 140A1 having the configuration described above. This example is also designed such that when AC voltage of 100 V is applied between each of the pairs of electrodes 449, heat of about 56 W is obtained and the temperature rise on the surface of the heating glass 140A is about 40° C. The electrical resistance value between the electrodes 149 in this case is about 280Ω.

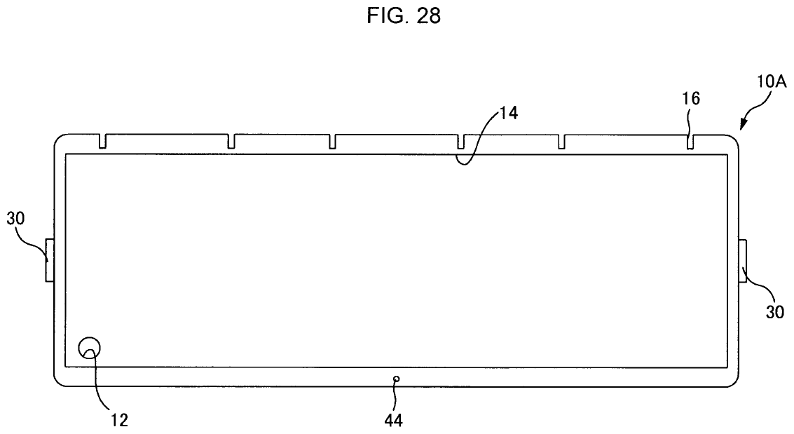

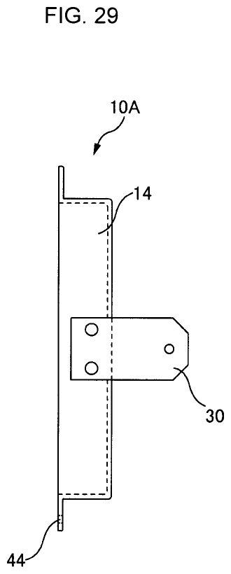

FIG. 28 illustrates a front view of the body 10A included in the traffic light device 1A of the second example, and FIG. 29 illustrates a right side view thereof. The body 10A has one recessed portion 14 for housing three light emitter units 70 provided in the openable and closable lid section 40, and the back surface thereof has an opening portion 12 for letting out a power supply cable from the light emitter units 70 and the heating glass 440. A bolt 40 for fixing the openable and closable lid section 400 is inserted through the hole portion 42.

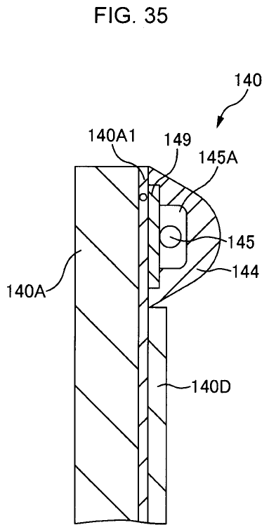

Next, a description is provided for a modified example common to the heater units 140, 240, and 440. FIG. 34 illustrates as an example a partial cross-sectional view of a modified example of the heater unit 140, and FIG. 35 illustrates a partial plan view thereof. In this modified example, a resin film 140D of appropriate material is attached on the conductive thin film 140A1 provided on the heating glass 140A. The solder 145A coupling the electrode 149 and the lead 145 together is covered by the silicone sealant 144. If the configuration is such that the resin film 140D is adhered to the heating glass 140A as the heater unit 140 as described above, it is possible to provide at a lower cost an effect of preventing scattering of the heating glass 140A when an impact force is applied.

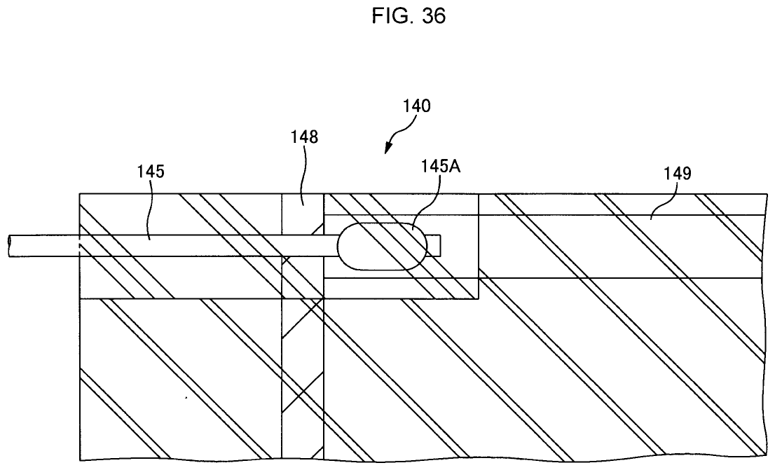

Next, a description is provided for a modified example of the rectangular plane-shaped heating glass 140. FIG. 36 illustrates a back view of the openable and closable lid section 100 provided with the heater unit 140 according to the modified example, in which the light emitter unit 70 and the spacer 150 are removed. FIG. 36 corresponds to FIG. 14 concerning the traffic light device 1 of the first example. This heater unit 140 according to the modified example is an example in which one conductive region 147 made of the conductive thin film 140A1 is formed by the two film-removed portions 148 between the pair of upper and lower electrodes 149. In the heater unit 140, 240, and 440 explained in the first and the second examples, the surface resistance value with high transparency is about 20Ω/□, and multiple conductive regions are formed using numerous film-removed portions 148 and the like so that the electrical resistance value between the electrodes is a value that meets the rated voltage of the power supply and the desired amount of heat generated. As opposed to this, although the present modified example has a somewhat reduced transparency compared to a heating glass having a surface resistance value of about 10Ω/□, the present modified example employs a heating glass having a surface resistance value of about 150Ω/□, reducing the number of film-removed portions for adjusting the electrical resistance value between electrodes. In addition, the width of the conductive region 147 is set almost equal to the diameter of the light emitter unit 70, making it possible to effectively prevent snow accretion which reduces visibility of the light emitting unit 110. This modified example is designed such that when AC voltage of 100 V is applied between the pair of electrodes 149, for example, heat of about 78 W is obtained and the temperature rise on the surface of the heating glass 140A is about 40° C. The electrical resistance value between the electrodes 149 in this case is about 150Ω. This makes it possible to obtain a sufficient effect of preventing snow accretion on the light emitting unit 110 of the traffic light device 1.

As described above, the traffic light device according to the embodiment of the present invention makes it possible to provide a traffic light device which uniformly heats a large region of a display section of the traffic light, enhancing a snow accretion prevention effect and maintaining visibility during snowfall.

The heater unit provided to the traffic light device can have a circular or rectangular heating glass. It is possible to obtain a temperature rise sufficient for exhibiting a snow accretion prevention effect of the heating glass by appropriately setting the conductive regions formed by a conductive thin film between a pair of electrodes provided to the heating glass and setting the surface resistance value of the conductive regions.

If two or more light emitter units are arranged side by side to each other in the traffic light device, one heater unit can be provided to these light emitter units. This configuration simplifies the configuration of the traffic light, making it possible to reduce assembly steps. Note that in this case, the conductive regions formed by the conductive thin film of the heating glass may be provided for each light emitter unit or may be provided across the light emitter units as arranged side by side.

It is possible to seal the traffic light device in a liquid-tight state if the heater unit of the traffic light device is configured to come into close contact with the fixing member which presses the heater unit to the periphery of an opening portion provided in the openable and closable lid section of the traffic light device and which is inclose contact with the heater unit between the opening portion and the light emitter unit. Here, it is possible to provide a gasket which is made of a material having elasticity and is formed in the shape of a flat plate between the heater unit and the periphery of the opening portion of the openable and closable lid section, and between the heater unit and the fixing member.

If the heater unit is laminated glass formed by bonding the heating glass to plate-shaped glass with an intermediate film in between, it is possible to enhance safety because scattering of glass when an impact is applied can be prevented. In addition, regarding the heating glass making up of the heater unit, if a resin layer is provided to cover the conductive thin film, it is possible to decrease cost without reducing the effect of preventing the scattering of glass.

The scope of the present invention is not limited to the embodiment described above, and other modified examples, application examples, and the like are included within the scope of what is described in the scope of claims.

### REFERENCE SIGNS LIST

1, 1A traffic light
10 body
70 light emitter unit
100, 200, 300, 400 openable and closable lid section
110, 210, 310, 410 light emitting unit
140, 240, 440 heater unit
140A, 240A, 440A heating glass
140A1, 240A1, 440A1 conductive thin film
140B, 240B, 440B plate-shaped glass
140C, 240C, 440C intermediate film
141, 143, 241, 243, 441, 443 glass gasket
142, 242, 442 gasket-pressing rib
150, 250, 450 spacer
152, 252, 452 annular erected portion (of spacers 150, 250, 450)
160, 260, 460 support block

1. A traffic light device for emitting signal light, comprising:
a light emitter unit which includes a light emitter being a light source of the signal light;
a housing unit which houses the light emitter unit; and
a heater unit provided on a path of the signal light emitted by the light emitter unit inside the housing unit, and including a plate-shaped heating glass, on a surface of which a conductive thin film having transparency is formed, and which generates heat when power is supplied to the conductive thin film via a pair of electrodes.

2. The traffic light device according to claim 1, wherein a light emitting section of the light emitter unit is formed in a substantially circular shape,
the heating glass is formed in a circular shape substantially the same as the light emitting section,
the conductive thin film is divided to form a set of conductive regions coupled in parallel between the pair of electrodes, and
an electrical resistance value of the conductive regions between the pair of electrodes is about 280Ω, which is set to obtain heat of about 35 W and a temperature rise of about 40° C. on a surface of the heating glass when AC voltage of 100 V is applied.

3. The traffic light device according to claim 1, wherein
a light emitting section of the light emitter unit is formed in a substantially circular shape,
the heating glass is formed in a substantially square shape having a side longer than a diameter of the light emitting section,
the conductive thin film is divided to form three sets of conductive regions coupled in parallel between the pair of electrodes, and
an electrical resistance value of the conductive regions between the pair of electrodes is about 210Ω, which is set to obtain heat of about 48 W is obtained and a temperature rise of about 40° C. on a surface of the heating glass when AC voltage of 100 V is applied.

4. The traffic light device according to claim 1, wherein
a light emitting section of the light emitter unit is formed in a substantially circular shape,
the heating glass is formed in a substantially square shape having a side longer than a diameter of the light emitting section,
the conductive thin film of the heating glass forms one conductive region between the pair of electrodes, and
an electrical resistance value of the conductive region between the pair of electrodes is about 130Ω, which is set to obtain heat of about 78 W and a temperature rise of about 40° C. on a surface of the heating glass when AC voltage of 100 V is applied.

5. The traffic light device according to claim 1, wherein
a plurality of the light emitter units are arranged side by side to each other in the housing unit, and
the heater unit is singly provided on paths of the signal light emitted by the plurality of light emitter units.

6. The traffic light device according to claim 5, wherein
a light emitting section of each of the light emitter units is formed in a substantially circular shape,
the conductive thin film of the heating glass forms three sets of conductive regions coupled in parallel between the pair of electrodes provided to sandwich each light emitter unit in a diameter direction, and
an electrical resistance value of the conductive regions between the pair of electrodes is about 210Ω, which is set to obtain heat of about 48 W and a temperature rise of about 40° C. on a surface of the heating glass when AC voltage of 100 V is applied.

7. The traffic light device according to claim 5, wherein
a light emitting section of each of the light emitter units is formed in a substantially circular shape,
the conductive thin film of the heating glass is divided to form a plurality of conductive regions coupled in parallel between the pair of electrodes provided to sandwich the light emitter units as arranged side by side in an arrangement direction, and
an electrical resistance value of the conductive regions between the pair of electrodes is about 180Ω, which is set to obtain heat of about 56 W and a temperature rise of about 40° C. on a surface of the heating glass when AC voltage of 100 V is applied.

8. The traffic light device according to claim 1, wherein
the heater unit seals an opening portion provided in the housing unit in a liquid-tight state when the heater unit is in close contact with a fixing member between the opening portion and the light emitter unit, the fixing member pressing the heater unit to a periphery of the opening portion while being in close contact with the heater unit.

9. The traffic light device according to claim 8, wherein
sealing members each made of a material having elasticity and formed in the shape of a flat plate are provided between the heater unit and the periphery of the opening portion of the housing unit, and between the heater unit and the fixing member.

10. The traffic light device according to claim 1, wherein
the plate-shaped heating glass of the heater unit forms a laminated glass by being bonded to a plate-shaped glass with an intermediate film in between.

11. The traffic light device according to claim 1, wherein
the heating glass of the heater unit includes a resin layer provided to cover the conductive thin film.
